(19) United States
(12) Patent Application Publication
(10) Pub. No.: US 2010/0031934 A1
(43) Pub. Date: Feb. 11, 2010

(54) INTERNAL COMBUSTION EXTERNAL COMPRESSION ENGINE

(76) Inventor: Seyyed Farhad Tayyari, Kermanshah (IR)

Correspondence Address: CENTURY IP GROUP, INC. [Main], P.O. BOX 7333, NEWPORT BEACH, CA, 92658-7333, US

(21) Appl. No.: 12/188,908

(22) Filed: Aug. 8, 2008

(51) Int. Cl. F02B 33/00

(52) U.S. Cl. 123/559.1

(57) ABSTRACT

An engine comprising at least one piston moving inside a cylinder in a first direction and a second direction, wherein the piston is in an operational relationship with a crankshaft such that each cycle of the crankshaft result from the piston moving once in each of the first and the second directions; and a compressor situated external to the cylinder for compressing air in an air tank, wherein the air after being externally compressed by the compressor is provided into a combustion chamber in the cylinder and mixed with fuel injected into the combustion chamber as the piston is moving in the first direction, and wherein the fuel/air mixture is ignited to generate a combustive force pushing the piston in the second direction.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### TECHNICAL FIELD

The present invention relates generally to combustion engines and, more particularly, to a system and method of an engine for externally compressing and internally combusting the air fuel mixture in an engine.

### BACKGROUND

The compression and combustion cycle in four stroke combustion engines involves compressing and combusting the fuel/air mixture inside the engine cylinder. Particularly, four strokes of the piston are needed for a full cycle. The four strokes are intake stroke, compression stroke, combustion stroke and exhaust stroke.

In such engines, a piston is connected to a crankshaft by a connecting rod. As the crankshaft revolves, it causes the piston to move up and down inside the cylinder. At the beginning of the intake stroke, the piston starts at its higher position inside the cylinder. As the intake valve opens, the piston moves down to let the engine take in the fuel/air mixture. In a diesel engine or a gasoline-based engine with a direct injection fuel system, only air is taken into the compression chamber at this point. During the compression stroke, the piston moves back up to compress this fuel/air mixture.

When the piston reaches the top of its stroke, a spark plug emits a spark to ignite the compressed fuel/air mixture. The compressed charge in the combustion chamber explodes, driving the piston down during the combustion stroke. Once the piston hits the bottom of its stroke, the exit valve opens and the exhaust leaves the cylinder to go out the tailpipe as the piston moves toward the top of the cylinder again during the exhaust stroke.

Systems and methods are needed to increase the efficiency of the current four stroke engines.

### SUMMARY

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, an internal combustion external compression engine is provided. In one embodiment, a compressor is utilized to perform the intake and compression processes external to the engine cylinder, while combustion and exhaust processes remain internal to the cylinder. As a result, each cylinder has a combustion in each revolution of the crank which results in the duplication of the number of combustions per piston cycle in comparison with a four-stroke engine.

Advantageously, an engine designed according to the above scheme has twice the power of a counterpart four-stroke engine with a similar volume and number of cylinders where the intake and compression processes are performed internally. For example, if a compressor and a compressed air tank are accordingly added to a four-stroke four-cylinder engine with the volume of 2000 cc, its power will exceed the power of an four-stroke eight-cylinder engine with the volume of 4000 cc having a supercharger.

If additional power is not required, the engine's RPM may be decreased to half by way of an electronic control unit (ECU), for example. Reducing the RPM to half provides additional time for the fuel combustion cycle resulting in more complete combustion and higher fuel efficiency. Such implementation will thus lead to a considerable decrease in fuel consumption and air pollution. Moreover, the lower RPM reduces engine utilization makes the engine more durable and reliable.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIGS. 1-9 illustrate various exemplary embodiments of the external compression internal combustion engine.

Features, elements, and aspects of the invention that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

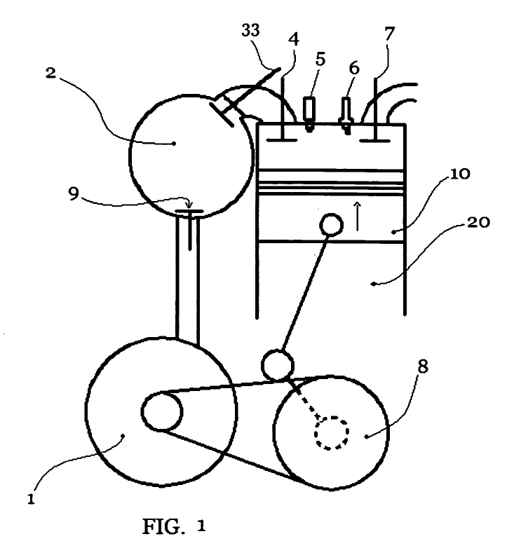

Referring to FIG. 1, an exemplary embodiment of the internal combustion external compression engine may include a compressor 1, an air tank 2, a primary entry valve 33, an entry valve 4, an injector 5, a spark plug 6, an exit vale 7, a crankshaft pulley 8, a unidirectional valve 9, a piston 10 and a cylinder 20. The piston 10 is configured to move in first and second directions (e.g., up and down) inside the cylinder 20.

The piston 10 is in an operational relationship with a crankshaft such that each cycle of the crankshaft results from the piston 10 moving once in each of the first and the second directions. A compressor 1 is situated external to the cylinder 20 for compressing air in an air tank 2. The air after being externally compressed by the compressor 1 rushes into cylinder 20 once entry valve 4 opens. As the piston 10 is moving in the first direction, air is mixed with fuel that is injected into the cylinder 20 by way of injector 5 to create the fuel/air mixture.

In one embodiment, after the compressed air is provided into the combustion chamber in cylinder 20, fuel is injected into the combustion chamber and the fuel/air mixture is then ignited by way of a spark plug 6 to generate a combustive force pushing the piston 10 in the second direction. Thereafter, the piston 10 moves back in the first direction inside the cylinder 20, in response to the revolution of the crankshaft, to cause exhaust generated from combustion of the fuel/air mixture to exit the cylinder from at least one exit valve 7.

Referring to FIGS. 1-8 depending on implementation, air needed by the engine may be compressed by a screw, axial, centrifugal, wankel or other type of compressor 1 and stored in an air tank 2 according to the compression ratio required by the engine. In one embodiment, the piston 10 moves up during an exhaust stroke to push the exhaust out of the cylinder. Approximately 40 to 50 degrees before reaching the top dead center (TDC) of the cylinder, the entry valve 4 opens (after the opening of the primary entry valve 33) and the compressed air enters the combustion chamber of cylinder 20.

In one embodiment, to avoid leakage of compressed air from entry valve 4 while entry valve 4 is in a close position, a primary entry valve 33 may be provided at an exit point from air tank 2 to maintain the compressed air inside air tank 2. Entry valve 4 and the primary entry valve 33 may be synchronized to open at approximately the same time to allow the compressed air exit air tank 2 and enter the combustion engine.

Desirably, the air entering the combustion chamber causes remaining exhaust from a previous combustion cycle to be evacuated from the combustion chamber until the exhaust valve 7 is closed. Then injector 5 starts injecting and the entry valve 4 is closed. The fuel/air mixture may be further compressed by the piston 10 before the spark plug 6 ignites the fuel/air mixture, desirably, when piston 10 reaches TDC. The piston 10 is driven down by the resulting combustion force. The piston 10 subsequently comes back up to push out the resulting exhaust from the combustion chamber and thus the cycle continues.

Advantageously, a four-stroke engine may be reconfigured according to the above to double the number of combustions (i.e., one combustion by each cylinder in each rotation of the crank). Such reconfiguration approximately doubles of the power of the engine (e.g., power of a four-cylinder 2000 cc internal combustion external compression engine may exceed the power of a four-stroke 8-cylinder, 4000 cc engine, equipped with a supercharger).

In one embodiment, no internal engine resources are utilized for the air intake and compression processes as the rotational compressor 1 can be operated efficiently and with less power in comparison with engines which have reciprocating air intake and compression. Even if the compressor 1 is of a reciprocating type, it uses less energy, since the yield of compressor 1 is more than that of an engine that also acts as a compressor. Higher yield of a reciprocating compressor compared to the intake and compression strokes in the engine results from lighter locomotive parts and operation in much lower temperatures, the engine's valves status and potential to work in higher RPMs.

In other words, a compressor 1 which is manufactured solely to compress air has a higher yield compared to an engine which is configured to operate as a compressor and is originally designed to create a chamber for proper combustion and production of power. Spending less energy for air intake and compression results in a reduction in fuel consumption. Depending on implementation, the compressor 1 may be powered by the engine crank through a gear wheel, belt, or chain.

In one embodiment, the temperature of the air entering the cylinder 20 from the air tank 2 is controllable. To increase the temperature of the air provided into the cylinder 20, the air tank 2 may be insulated to prevent heat dissipation. Alternatively, a heating element (e.g., a glow plug) may be installed in the air tank 2 or the channel of entry of air to the cylinder, or inside the combustion chamber. The temperature may also be increased through achieving a higher air compression and pressure.

In some embodiments, to reduce temperature of the air entering the cylinder 20, the air tank 2 may be manufactured from materials with a high heat exchange coefficient. Alternatively, an intercooler may be used or air tank 2 is principally manufactured in an intercooler feature. Further, the level of pressure in the air tank 2 (e.g., increasing or decreasing the pressure level by way of taking into account a higher or lower RPM for compressor 1) can be used to increase or decrease the speed of air entering the combustion chamber of cylinder 20.

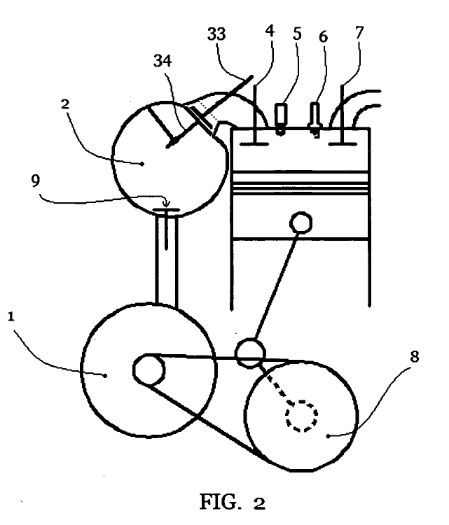

Referring to FIG. 2, an electric valve 34 may be installed at an opening leading to the channel connecting the air tank 2 to the entry to the cylinder 20 in which the primary entry valve 33 and the entry valve 4 are located. The electric valve 34 in a closed position prevents leakage of compressed air from the air tank 2, when the engine is turned off. Desirably, when the engine is being turned off, first the electric valve 34 is closed to block the connection of the air tank 2 to the entry channel of cylinder 20; then the engine's electric current or fuel is shut off, and the engine is turned off.

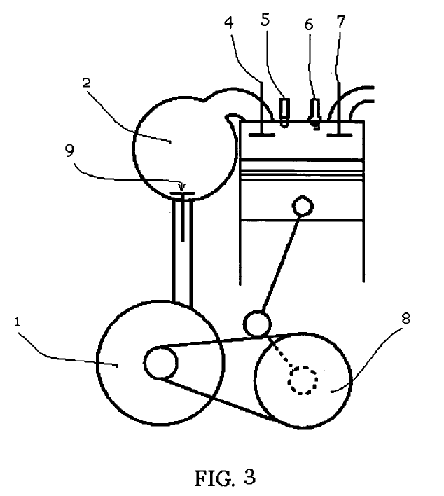

Referring to FIG. 3, in one embodiment, entry valve 4 comprises a biasing member (e.g., spring) that is strong enough to keep entry valve 4 shot against the compressed air force in air tank 2, and prevent any leakage of compressed air to the cylinder 20. In such embodiment, there may be no need to the install a primary entry valve 33.

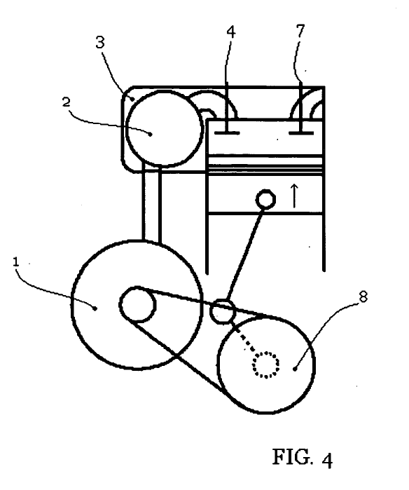

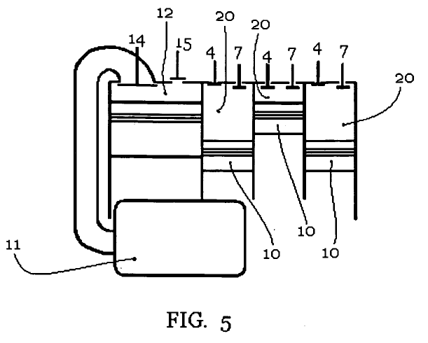

Certain embodiments may be manufactured as gasoline-based or diesel- based engines. Referring to FIG. 4, air tank 2, particularly in diesel engines, may be provisioned in the form of a hole inside the cylinder head. Referring to FIG. 5, the process of air compression in one embodiment may be conducted in two phases: first through the primary compressor 11 (e.g., a rotational compressor) and then through a secondary reciprocating compressor 12 (e.g., propelled directly by the crankshaft) designed inside the cylinder block.

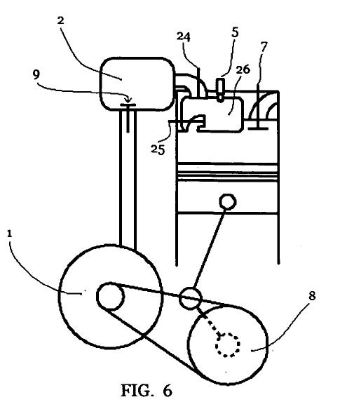

One embodiment may include a separate combustion chamber as shown in FIG. 6. In this embodiment, when the piston 10 at the end of the exhaust stroke is reaching the TDC, after the closing of the exhaust valve 7, the outlet valve 25 of the combustion chamber 26 is opened and the fuel is injected into the hot air inside the combustion chamber 26 by the injector 5, resulting in the combustion. The combusted fuel and air enter the cylinder chamber through the exiting channel of the combustion chamber 26. The combustion force drives down the piston, which already reached the TDC.

When the piston reaches the BDC, with the exhaust stroke being started and after the opening of the exhaust valve 7, the inlet valve 24 of the combustion chamber 26 is opened and the air which is approximately compressed up to the compress ratio required by the engine enters the combustion chamber and causes the smoke to be driven out of the combustion chamber 26. The outlet valve 25 of the combustion chamber 26 is closed and after the filling of the combustion chamber 26 with the compressed air, the inlet valve 24 of the combustion chamber is closed. During the exhaust stroke, the compressed air, which was heated due to compression, is trapped in the combustion chamber 26 and due to the very high temperature of the combustion chamber 26, its temperature is increased and reaches a more suitable temperature for fuel injection and ignition.

When the piston 10 is at the end of the exhaust stroke on the verge of TDC, first the exhaust valve 7 is closed. Then, the outlet valve 25 of the combustion chamber 26 is opened and the fuel is injected in the very hot air, resulting in combustion of the fuel. As mentioned above, the power production process is repeated. In order to increase the temperature of the air trapped in the combustion chamber, the method of combustion chamber insulation may be used for the reduction of heat exchange coefficient and or the use of glow plug and or both methods. The advantage of designing internal combustion external compression engines in this way is that the compressed air has more time to enter the combustion chamber.

In the following, we discuss the advantages of the various embodiments disclosed above in comparison with a four-stroke engine with similar volume and number of cylinders.

Considerable reduction of the fuel consumption: In high RPMs, piston engines have lower yields, the reason being that in high RPMs, the cylinders are not completely filled and for the conduct of optimum combustion, the sufficient time is not provided, which leads to the reduction of the yield and increase of the fuel consumption. To decrease fuel consumption, the duplication of engine power may be prevented through ECU and lowering its RPM to half. In this situation, because the RPM is lowered to half, double the time is available for fuel combustion. In such a situation, the fuel has a more complete combustion and as a result more energy is generated. In addition to considerably decreasing the fuel consumption, this results in the lowering of polluting effects of the combustion. Spending less energy for air intake and compression, variability of the compression ratio and the volume of air input to the engine, each in turn, contributes to the reduction of the fuel consumption.

Decrease in the pollution rate due to the lower fuel consumption and more complete combustion process, resulting from the low RPM and a longer time for fuel combustion.

A high power and torque in lower RPMs and in fact, the duplication of power and torque in different RPMs. The use of internal compression external combustion engines (ICEC) leads to an increase in the power and torque in the vehicle, which exceeds the duplication level and provides better conditions for manufacturing of sport cars, with a lower weight and cost price.

Smoother functioning of the engine. Since the angle difference of pistons movements with each other is half that of four-stroke engines, for example, in 4-cylinder ICEC engines, the angle difference between the pistons movements is 90 degrees, compared to 180 degrees of angle difference in 4-cylinder four-stroke engines. 2-cylinder ICEC engines work as smoothly as 4-cylinder four-stroke engines and 3-cylinder ICEC engines work with the same smoothness of 6-cylinder four-stroke engines, and 4-cylinder ICEC engines have a smoother functioning compared to 6 & 8-cylinder four-stroke engines. Smoother functioning of the engine facilitates the application of a smaller and lighter flywheel in this type of engine, which is effective in the decrease of the engine weight. Moreover, the lower shakes & vibrations of the engine may in turn reduce the depreciation of the engine and some other parts of the vehicle.

A higher reliability of the engine and lower depreciation, due to an RPM lowered to half. Moreover, its lower depreciation results in an opportunity to manufacture the engine with materials of less strength, in turn leading to lower production costs.

No need for a supercharger and turbocharger. Taking into account a higher RPM for compressor, naturally leading to a higher pressure of the compressed air tank, the engine actually works as the engines equipped with superchargers or turbochargers.

Having access to compressed air for different uses such as air brake system, tire pumping, etc., and in lorries and buses, a separate compressor for pneumatic air tank is not needed and with the increase of the engine's compressor RPM, the air inside the vehicle air tank too may be provided.

Since most main parts of this engine are common with current four-stroke engines, all the existing knowledge and experiences of designing and manufacturing methods are identical and applicable to this engine. Consequently, the time and expenses of research for manufacturing and exploitation of ICEC engine is at a minimum level.

Lower volume, weight, and manufacturing expenses: Due to its very high power, the engine of a vehicle may be manufactured with lower number of cylinders and smaller sizes, which decreases the manufacturing costs.

Since the input air has a high pressure, it quickly and easily enters the combustion chamber in a sufficient volume and there is no need for application of multiple inlet valves, and even the air pressure may open the inlet valves installed at the combustion chambers and the use of camshaft force for their opening is not very essential. In four-stroke engines, the cylinder is not completely exhausted from smoke and always some smoke, at least with the size of the combustion chamber volume remains inside the cylinder. However, in this engine, the input air, completely expels the smoke from the combustion chamber.

If bigger compressed air tanks, with higher heat exchangeability are used, the compressed air loses its heat and its volume is decreased, resulting in the entry of more air, with higher compression to the combustion chamber. This situation, in fact has the effect of the increase of the cylinder volume and compression level, which leads to achieving a higher power and yield.

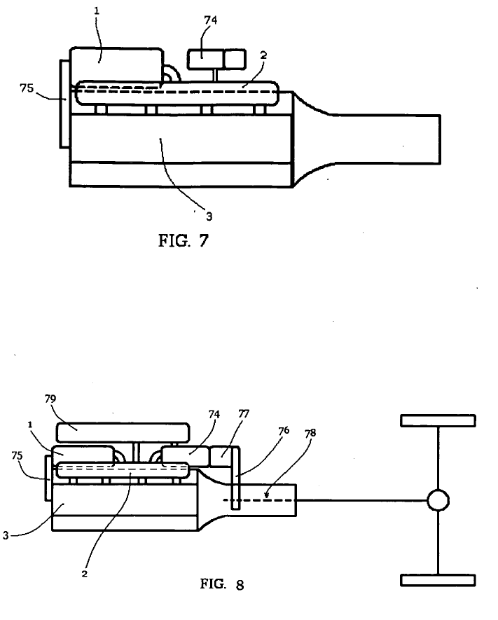

Possibility of making variable the ratio of compression and the volume of the air entering the cylinder. In gasoline-based engines, the promotion of compression ratio, is of a special significance in upgrading the performance and yield quality and may lead to the promotion of the efficiency and the lowering of fuel consumption. However, the increase of the compression ratio, when the engine temperature is increased during time when the engine functions under high pressures or when the weather is hot, the fuel is combusted by itself before the spark plug ignition and causes the knock phenomenon, which is harmful for the engine. This problem may be removed in ICEC engines through adding a pressure increase compressor 74 to promote the pressure of the air tank 2, which is propelled by an electromotor (see FIG. 7).

When the air temperature and the engine temperature, which are reported to ECU by the related sensors, make feasible compression ratio increase, the pressure increase compressor 74 is activated, which increases the pressure of the air tank and considering the temperature, creates the possible highest compression ratio. With the application of this system, when the engine is cold at the start up time and when the vehicle is used in cold seasons or in cold regions, the engine works with a higher compression ratio.

The increase of the pressure of the air entering the cylinder, also means the increase of the air entering the cylinder; for example, the cylinder with the capacity of 500 cc and a combustion chamber with the capacity of 50 cc (compression ratio of 10/1), in ordinary situations 50 cc of the compressed air, which is compressed by 10 times enters the combustion chamber, however, with the startup of the pressure increaser compressor, 50 cc of the compressed air, which is for example compressed by 12 times enters the combustion chamber, which not only causes the increase of the compression ratio, but also 600 cc of air enters the combustion chamber, i.e. the efficiency of the 500 cc cylinder, with the compression ratio of 10/1 shall be equal to the efficiency of an 600 cc cylinder, with the compression ratio of 12/1.

Increasing of the compression ratio at the start up, results in not only the yield promotion, but also the quicker warm up of the engine and reaching the desirable temperature more promptly. However, considering the recognition of pressure change of the tank air and the engine temperature through respective sensors, ECU determines the best fuel injection size. If the engine is not started for a long time and in case there is a pressure downfall of the air inside the tank, in order to turn on the engine before its starting up, the pressure increase compressor 74 is activated and the pressure of the inside the air tank 2 reaches to a point that the engine may be started quickly and easily.

In case of the application of pulleys with variable diameters for the connection of crankshaft and shaft of the engine's main compressor 1, so that in necessary times, the promotion of the compressor RPM is made possible through decrease of the compressor pulley's diameter and increase of the crankshaft pulley's diameter, the installation of a pressure increaser compressor 74 shall not be required. If the main compressor 1 and the pressure increase compressor 74, both are of rotary (Wankel) type, then they are installed in a parallel array against each other. However, if pressure increase compressor 74 or both compressors are targeted to be centrifugal or axial, they should be installed in a series array against each other.

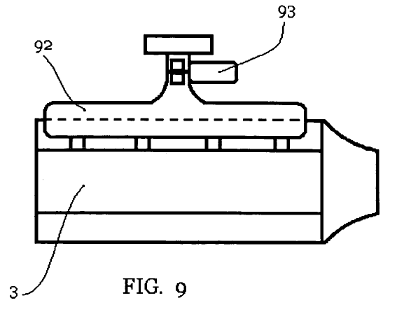

In one embodiment, the system of making variable the ratio of compression and the volume of the air entry to the cylinder is applicable to the four-stroke engines too. To this end, pulleys with variable diameters may be used for crankshaft and supercharger, so that when the increase of the compression ratio is possible, the supercharger pulley's diameter is decreased and the crankshaft pulley's diameter is increased, resulting in the functioning of the supercharger with a higher RPM and more air is driven to the cylinders with higher pressure, or a supercharger with the electrical compressor 93 may be used which is activated when the increase of the compression ratio is possible, leading to the increase of the amount and pressure of the air entering the cylinder (see FIG. 9).

In four-stroke engines, with variable compression ratio, when the weather or the engine is cold, and the compression ratio may be increased without creating self-combustion and the knock phenomenon, this state is reported to ECU through some sensors, resulting in the activation of the electrical compressor 93 and the increase of air pressure in the inlet manifold 92. Increase of the air pressure entering to the cylinders, naturally leads to the promotion of the compression ratio and brings about a higher yield for the engine.

The electrical compressor 93 has a variable RPM and its RPM is synchronized by the ECU with the engine RPM at any moment and in proportion to the amount of the increase of the compression ratio. Where the engine has a supercharger, which is propelled by pulleys with variable diagonal, an electric compressor 93 is not needed. In this way, where the increase of the compression ratio is feasible, the diagonal of the supercharger's pulley is decreased and the diagonal of its propellant pulley, which is connected to the crank-shaft is increased, in this situation, the supercharger RPM is increased and more air is pumped into the inlet manifold 92.

Having more desirable conditions and less expensive for the exploitation of electrical energy to propel the vehicle (manufacturing of hybrid vehicles). If the pressure increase compressor 74 (for the increase of compression ratio in the cold weather) and its electromotor 77 are designed in a big size and high power potential, so that the compressor can independently pump the air required by the engine during different RPMs into the air tank 2, the electrical energy shall substitutes the amount of fuel, which produces the energy for air intake and compression of the engine. In this manner, the vehicle is actually and easily converted to a hybrid one, with no need to design and exploit quite expensive, complicated and heavy systems usually used in ordinary hybrid vehicles (see FIG. 8).

During braking operation, the electromotor 77 and compressor 74 are connected to the output shaft of the gearbox 78 by the electromagnetic clutch 76 and the wheels of the vehicle propel the electromotor 77 and the compressor 74. In this situation, the electromotor 77 is converted to a generator and batteries are charged. The compressor 74 too, fills the extra air tank 79 with the compressed air. The air from this tank is used in the engine or spent for other purposes. This is one of the other advantages of this system compared to ordinary hybrid systems, where at breaking, the kinetic energy of the vehicle is further and doubly recovered.

The main compressor 1 of the engine exists in its place, so that when the set of batteries cannot afford to provide the sufficient energy needed by the electrical compressor 74, the main compressor 1 is connected to the engine by the electromagnetic clutch 75 and provide the air required by the engine. The set of batteries of the electrical compressor 74 are charged up through connection to the urban electrical power, like the batteries of the ordinary hybrid vehicles, which during the charging of the batteries, using the urban utility electricity, the electrical compressor 74, too, fills the extra air tank 79 with the quite compressed air.

Potentiality of a higher compatibility with the water injection system. If in the combustion chamber of four-stroke engines, a water injector is installed, the engine is converted to a six-stroke engine, so that after the exhaust course, all the valves are closed and the water injector injects some water in the combustion chamber. Due to the high temperature of the combustion chamber, water is completely vaporized and its volume is highly increased. This increase of water volume in the closed environment of the combustion chamber produces a force, which results in pushing down the piston. Afterwards, the piston comes up and exhausts the water vapor from cylinder to the condenser. The problem arises when the engine is cold and the production of force through the water injection is impossible (such as working of the engine at the startup time).

In this situation, it is in fact a six-stroke engine, working based on the power production by only one of its strokes and its other five strokes are power consuming, which results in a serious disorder in the engine functioning. However, in ICEC engines, the water injection system is more practical and when the engine is cold there is no water injection, the engine works like a four-stroke engine and due to its higher number of combustions, is heated more quickly, and reaches the proper temperature for the water injection.

After reaching the proper temperature and the injection of water, it is converted to an engine, which in each rotation of the crankshaft, any one of the cylinders has a power stroke in the format: 1-power (fuel combustion) 2-exhaust (smoke) 3-power (through the vapor force) 4-exhaust (vapor). When this format is compared to the six-stroke engine cycle in the 1-intake 2-compression 3-power (fuel combustion) 4-exhaust(smoke) 5-power (through the vapor force) 6-exhaust (vapor) format, it is found out that contrary to the six-stroke engine, which after two power courses has a course of non-production of power (intake), power courses in each crankshaft rotation are conducted consecutively and without any break, which results in a more balanced and smoother functioning of this engine. Moreover, in six-stroke engine, in the intake course, the combustion chamber loses some of its heat, leading to production of less force when water is injected.

It should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. An engine comprising:
at least one piston moving inside a cylinder in a first direction and a second direction, wherein the piston is in an operational relationship with a crankshaft such that each cycle of the crankshaft result from the piston moving once in each of the first and the second directions; and
a compressor situated external to the cylinder for compressing air in an air tank,
wherein the air after being externally compressed by the compressor is provided into a combustion chamber in the cylinder and mixed with fuel to create a fuel/air mixture as the piston is moving in the first direction, and
wherein the fuel/air mixture in the combustion chamber is ignited to generate a combustive force pushing the piston in the second direction.

2. The engine of claim 1, wherein the piston moves back in the first direction to cause exhaust generated from combustion of the fuel/air mixture to exit the cylinder from an exit point.

3. The engine of claim 2, wherein the compressed air is provided into the combustion chamber from an entry point in the cylinder, wherein the entry point is secured by a first valve, wherein the first valve opens to allow the compressed air into the combustion chamber.

4. The engine of claim 3, wherein exhaust inside the combustion chamber is forced out from the exit point in the cylinder as the compressed air is provided into the combustion chamber through the first opening while the first valve is open.

5. The engine of claim 4, wherein the exit point is secured by a second valve that closes after the exhaust is forced out from the exit point.

6. The engine of claim 5, wherein the first valve closes when fuel is injected into the combustion chamber.

7. The engine of claim 6, wherein the entry point to the cylinder and an exit point from which compressed air exits the air tank are connected by way of an air-tight channel.

8. The engine of claim 7, wherein the exit point from the air tank is secured by way of a primary entry valve, such that the primary entry valve is synchronized to approximately open and close with the first valve.

9. The engine of claim 8, wherein the primary entry valve opens prior to the first valve opens to allow the compressed air to be provided into the combustion chamber via the air-tight channel.

10. The engine of claim 9, wherein the primary entry valve remains closed while the first valve is closed to prevent air leakage from the first valve into the cylinder
